(19) United States
(12) Patent Application Publication
(10) Pub. No.: US 2022/0092499 A1
(43) Pub. Date: Mar. 24, 2022

(54) APPARATUS AND METHOD FOR CONVERTING DATA FROM A DIGITAL CUSTOMER INTERFACE OF A COMPUTER NETWORK SYSTEM

(71) Applicant: PHOENIX CONTACT GMBH & CO. KG, Blomberg (DE)

(72) Inventors: Peter KELLER, Oerlinghausen (DE); Matthias TIEBEN, Bad Salzuflen (DE); Jorg SCHMIDT, Petershagen (DE)

(21) Appl. No.: 17/292,397

(22) PCT Filed: Nov. 8, 2019
(86) PCT No.: PCT/EP2019/080717

§ 371 Date: May 7, 2021

(30) Foreign Application Priority Data
Nov. 9, 2018 (EP) 18205474.2

(51) Int. Cl. G06Q 10/06; G06Q 30/06

(52) U.S. Cl. CPC G06Q 10/06315; G06Q 30/0641; G06Q 30/0633

(57) ABSTRACT

The present invention relates to a method for converting data from a digital customer interface of a computer network system. The method includes acquiring standard functions both from participating systems of the computer network system and from the digital customer interface, determining semantic relationships between the acquired standard functions, and performing an orchestration in the form of a flexible combining of the acquired standard functions based on the determined semantic relationships to a data composition for internal material and/or value flows.

### TECHNICAL FIELD

The present invention relates to systems for data transformation by standardized transformation processes and corresponding data migration methods for computer aided manufacturing.

In particular, the present invention relates to an apparatus and method for transforming data from a digital customer interface of a computer network system.

### TECHNICAL BACKGROUND

Data on products exist in a company in the areas of product procurement, production and distribution. An end-to-end implementation of wide-ranging data availability and data transformation within the entire computer network system of a company is difficult to achieve.

### SUMMARY OF THE INVENTION

It is an object of the present invention to provide an improved apparatus and method for transforming data from a digital customer interface of a computer network system.

This object is solved by the objects of the independent patent claims. Further embodiments and embodiments can be found in the dependent claims, the description and the figures of the drawings.

A first aspect of the present invention relates to a method for converting data from a digital customer interface of a computer network system, the method comprising the following method steps.

As a first method step, a detection of standard functions of both involved systems of the computer network system and the digital customer interface is performed.

As a second method step, semantic relationships between the acquired standard functions are determined, wherein the captured standard functions include standard functions of the involved systems of the computer network system as well as standard functions of the digital customer interface.

As a third process step, an orchestration is performed in the form of a flexible combination of the captured standard functions based on the determined semantic relationships to a data composition for internal material and/or value flows.

The present invention enables data from a product configurator to be transformed into standardized internal material and value flows by transformation model.

The present invention enables to react in an adapted and customized way to different configuration scenarios, for example the method can switch on different modes, for example a standard and/or a simulation mode, to perform for example different tasks in the transformation model.

The transformation model automatically transfers extensive data packages to almost all systems relevant for order processing and manufacturing of a product and thus represents a core technology for intelligent production.

The method does not use its own program logic, but works on the one hand on semantic relationships that are present in the standard functions of the systems involved, a web configurator, a web store, a simulation system, enterprise resource planning system, a production control system, or an automatic assembly aid This results in a number of improvements, particularly in the context of Industry 4.0.

The present invention advantageously enables to realize the standardization of processes even in heterogeneous IT infrastructures, ensuring digital consistency.

Advantageously, the present invention enables any configured solution to also be digitally and immediately orderable, even if it has not yet been produced in the manufacturing systems and does not yet exist as such.

By automating the material system during the ordering process, internal efforts are significantly reduced and lead times for production orders are significantly minimized.

Standardization and automation improve data quality within the company. The transformation model includes a procedure for converting data from the digital customer interface, also known as the web configurator, into standardized internal material and value flows to control the automated management of machines, equipment, production processes.

The acquisition of standard functions both from participating systems of the computer network system and from the digital customer interface can thereby comprise, for example, a definition of standard functions and the method according to the invention assigns, for example, acquired functions or work steps, as they are performed in a heterogeneous IT system, to the now defined standard functions.

In other words, functions or work steps performed by certain subsystems of the heterogeneous IT system are recorded as a standard function, thereby achieving digital consistency of the heterogeneous IT system.

In this context, determining the semantic relationships between the captured standard functions may include, for example, checking the logical properties or, for example, the input-output behavior of a procedure of the captured standard functions.

Further, determining the semantic relationships between the captured standard functions may also comprise, for example, operational checking of the captured standard functions, and data relation or relations of execution steps as pairs of the captured standard functions are checked, for example.

Orchestration in the form of flexibly combining the captured standard functions may be understood as, for example, automated configuration, coordination, and management of all captured standard functions.

Orchestration in the form of flexible combining of the captured standard functions includes, for example, an automation of the hardware and software configuration of the heterogeneous IT infrastructure based on the determined semantic relationships to a data composition for internal material and/or value flows.

Orchestration in the form of flexible combination of the captured standard functions includes, for example, service-oriented architecture, virtualization, provisioning and, in particular, specific adaptation to objectives, requirements and targets. The specific objectives and targets, also described as “quality of service parameters” and/or define the application optimization goals.

The optimization system according to the invention is oriented, for example, to the various configuration scenarios of the heterogeneous IT system and combines, for example, functions for transparency, optimization and acceleration of the data processing provided by the standard functions in a holistic approach.

The focus is, for example, on the precise control of the data processing on an analysis of the semantic relationships of the recorded standard functions of the systems involved and of the applications.

Advantageous embodiments of the present invention can be found in the dependent claims.

In an advantageous embodiment of the present invention, it is provided that as the involved systems: a web configurator, a web store, a simulation system, enterprise resource planning system, a production control system, or an auxiliary assembly machine are used.

In an advantageous embodiment of the present invention, it is provided that the data composition for the internal material and/or value flows is transmitted to the involved systems and/or to the digital customer interface.

The data composition for the internal material and/or value flows can thereby represent real material flows and/or real value flows by a suitable data format and provide data for external and internal information requirements about the real material and/or value flows.

In an advantageous embodiment of the present invention, performing the orchestration comprises applying a data transformation to the captured standard functions.

In an advantageous embodiment of the present invention, it is provided that based on the data composition for the internal material and/or value flows, automated control of production machines or production facilities coupled to the computer network system is performed.

In an advantageous embodiment of the present invention, it is provided that the flexible combining of the acquired standard functions based on the determined semantic relationships to the data composition for internal material and/or value flows is performed upon completion of an ordering process of the digital customer interface.

In a second aspect of the present invention, there is provided an apparatus for transforming data from a digital customer interface of a computer network system, the apparatus comprising an acquisition module, a semantics module, and an orchestration module:

The acquisition module is configured to acquire standard functions both from participating systems of the computer network system and from the digital customer interface.

The semantics module is configured to determine semantic relationships between the captured standard functions. The captured standard functions include standard functions of the involved systems of the computer network system as well as standard functions of the digital customer interface.

The orchestration module is configured to perform an orchestration in the form of a flexible combination of the captured standard functions based on the determined semantic relationships into a single data composition for internal material and/or value flows.

In other words, a fusion of the captured standard functions by means of the determined semantic relations into a hybrid data composition is performed, which serves as a basis for data processing in the entire computer network system.

In an advantageous embodiment of the present invention, it is provided that the device further comprises a data transmission module which is designed to transmit the data composition for the internal material and/or value flows to the systems involved and/or to the digital customer interface.

In an advantageous embodiment of the present invention, it is provided that the apparatus for transforming data is further adapted to be operated in a standard mode or in a simulation mode.

In an advantageous embodiment of the present invention, it is provided that the apparatus for transforming data is further adapted to perform flexible combining of the captured standard functions based on the determined semantic relationships to the data composition for internal material and/or value flows upon completion of an ordering process of the digital customer interface.

In a third aspect of the present invention, there is provided a computer network system comprising the apparatus according to the second aspect of the present invention to perform

In a fourth aspect of the present invention, there is provided a computer program or computer program product comprising instructions that, when executed by a computer, cause the computer to perform the steps of the method for converting data from a digital customer interface of a computer network system in accordance with the first aspect of the present invention.

In a fifth aspect of the present invention, there is provided a computer readable (storage) medium comprising instructions which, when executed by a computer, cause the computer to perform the steps of the method for converting data from a digital customer interface of a computer network system in accordance with the first aspect of the present invention.

The present embodiments and further embodiments may be combined with each other as desired.

Other possible embodiments, further embodiments and implementations of the present invention also include combinations of features of the present invention described previously or hereinafter with respect to the embodiments that are not explicitly mentioned.

The accompanying drawings are intended to provide a further understanding of embodiments of the present invention.

The accompanying drawings illustrate embodiments and, in connection with the description, serve to explain concepts of the present invention.

Other embodiments and many of the advantages mentioned will be apparent with reference to the figures of the drawings. The elements shown in the figures of the drawings are not necessarily shown to scale with respect to each other.

### BRIEF DESCRIPTION OF THE FIGURES

FIG. 1: shows a schematic diagram of a device for converting data from a digital customer interface of a computer network system according to an embodiment of the present invention;

FIG. 2: shows a schematic diagram of a flowchart of a process for converting data from a digital customer interface of a computer network system according to an embodiment of the present invention; and

FIG. 3: shows a schematic diagram of a process visualization of a method for converting data from a digital customer interface of a computer network system according to an embodiment example of the present invention.

### DETAILED DESCRIPTION OF THE EMBODIMENTS

In the figures of the drawings, identical reference signs denote identical or functionally identical elements, parts, components or process steps, unless otherwise indicated.

The term “participating systems of the computer network system” as used by the present invention may refer to any subunit of the computer network system. For example, a heterogeneous computer network system may have a plurality of so-called subsystems or subunits, where subsystem or subunit may refer to computer devices, which cooperate in a networked manner and are thus involved.

The term “internal material and/or value flows” as used by the present invention may refer to material and/or value flows behind a digital customer interface of a computer network system.

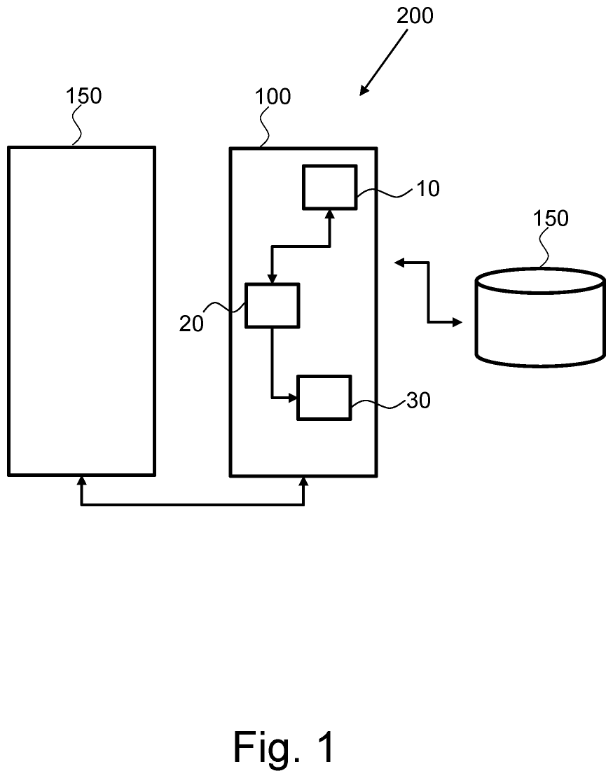

FIG. 1 shows a schematic diagram of a device for converting data from a digital customer interface of a computer network system according to an embodiment of the present invention.

FIG. 1 shows a computer network system 200 comprising further network computers 150, wherein the computer network system 200 is coupled to the device 100, wherein the computer network system 200 comprises, for example in an embodiment example, a web configurator, a web store, a simulation system, enterprise resource planning system, a production control system, or an assembly aid machine.

The apparatus 100 includes an acquisition module 10, a semantics module 20, and an orchestration module 30.

The acquisition module 10 is configured to acquire standard functions from both participating systems of the computer network system and the digital customer interface.

The semantics module 20 is configured to determine semantic relationships between the captured standard functions. The captured standard functions include standard functions of the involved systems of the computer network system as well as standard functions of the digital customer interface.

The orchestration module 30 is designed to perform an orchestration in the form of a flexible combination of the captured standard functions based on the determined semantic relationships into a single data composition for internal material and/or value flows.

In this context, the orchestration may be performed as follows:

An orchestration may be designed to retrieve an image file generated by the configurator from the CAD server during a configuration and store it automatically in a database system.

For example, a configuration is performed, the configuration result starts a process, the configuration result is fetched from the configurator, for example, and the configuration result is stored in central database.

The material system is released automatically, for example, and the material is created in Teamcenter, for example, and the product image is automatically imported into the database system, for example.

According to an embodiment example of the present invention, the customer logs into the customer interface of the acquisition module 10 with his user login and configures his product in a customer-specific manner.

According to an embodiment example of the present invention, a sales document simulation—i.e. the generation of a sales document—is simulatively executed on request with the data of the customer interface and the configurator, in order to bring the customer-specific information such as prices, delivery dates—and quantities in the customer interface to the user for viewing.

According to an embodiment example of the present invention, if no product defined in the reference database is found with the configuration result, the method uses for the transfer to the sales document simulation a configurable material that is uniquely described by characteristics and characteristic values.

According to an embodiment example of the present invention, in case the configuration result is a list of materials to be held together with a header material, the existence in the reference database is also checked.

According to an embodiment example of the present invention, in the case where this combination of items does not exist, for example, the header material is created as a copy of a non-stock material and the components are assigned as a sales bill of material.

According to an embodiment example of the present invention, when the user saves the configuration result, the method reserves in the PLM system a material number with which in the later course the configuration is retrievable and can be reordered.

According to an embodiment of the present invention, for example in the case that the user requests a quotation based on a non-existing configuration, the configurable material continues to be used initially, but the program outputs the reserved material number to the customer.

According to an embodiment of the present invention, when the quote is changed to an order, the data preparation of the saleable item starts. For this purpose, the “static data”—Represents a basic family—is copied from the template material and the “dynamic data” is copied from the configuration result of the quotation.

According to an embodiment example of the present invention, the configuration result is additionally stored with the material—base data 2 of the material master—for further support of the subsequent processes. Subsequently, the material plant is triggered with the prepared data in the transformation model.

According to an embodiment example of the present invention, when the customer sends the order confirmation, the preparation of the logistic data starts. For this purpose, the “static data” of the template material (e.g. MRP views) are copied and the “dynamic data” are generated based on the configuration, such as bill of material and routing

According to one embodiment of the present invention, the following steps are performed for each configuration:

i.) List of material numbers (i.e., configured components) and/or configuration descriptive parameters are extracted from the web configuration software;
ii.) Simulation mode: extract price, weights, volumes, and other item properties and display results in the web store;
iii.) assign material number in Teamcenter and save material number in configuration; and
iv.) Execution mode: creating a sales order that continues the configured item in SAP.

According to an embodiment of the present invention, the specification of the configured item describes the required functionality according to step iv.) as shown above.

In other words, a sales document, such as an order or a request, exists with at least one configured item, i.e., there exists a number for the sales document and at least one item.

According to an embodiment of the present invention, the required functionality comprises the automatic creation of, for example, properties to be defined, such as:
Material master;
Changes to the material master.

According to an embodiment of the present invention, the method determines a solution to the decision: change profile available in the configuration, but as a template to create a new change master record with, for example, the annotation “valid-from date =current date”

According to an embodiment of the present invention, further configured data in the profile may be defined by:
Production BOM; and/or
routing; and/or
price condition record; and/or
selling price; and/or
Calculation of production costs of the item; and/or
Creation of accounting views, where this includes, for example, calling the program for validation.

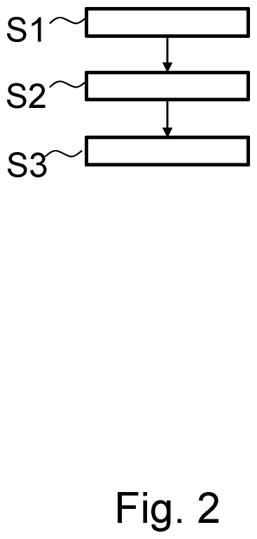

FIG. 2 a schematic diagram of a flow chart of a method for converting data from a digital customer interface of a computer network system according to an embodiment example of the present invention.

As a first method step, a detection S1 of standard functions of participating systems of the computer network system as well as of the digital customer interface is performed.

As a second method step, semantic relationships between the acquired standard functions are determined S2.

As a third process step, S3 orchestration is performed in the form of flexible combination of the captured standard functions based on the determined semantic relationships to form a data composition for internal material and/or value flows.

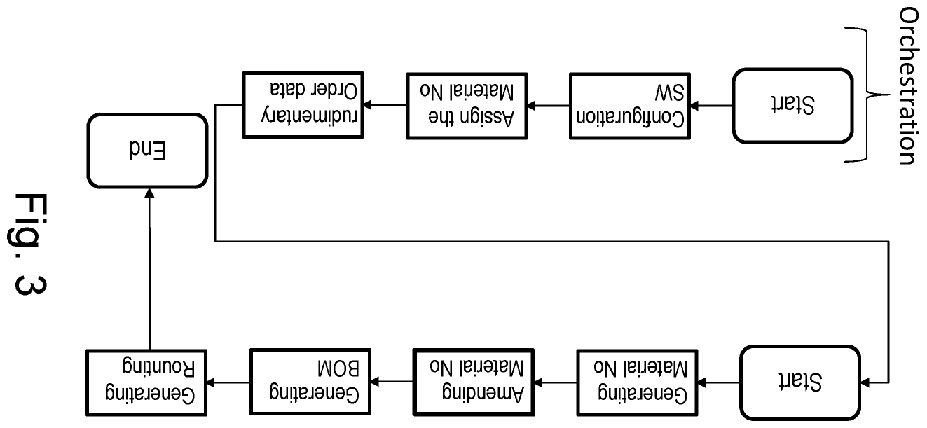

FIG. 3 shows a schematic representation of a process visualization of a method for converting data from a digital customer interface of a computer network system according to an embodiment example of the present invention.

The overall process illustrated in FIG. 3 includes a software module process, shown in the right column, and an orchestration process, shown in the left column.

For example, the orchestration process may include a trigger mechanism, wherein the report is invoked when a new sales document is present.

For example, the orchestration process may have a start condition, such as a sales document is created with a configured product, and the configuration is available as an item in the document.

For example, the orchestration process may be a monitoring process.

Although the present invention has been described above with reference to preferred embodiments, it is not limited thereto, but can be modified in a variety of ways. In particular, the invention can be changed or modified in a variety of ways without departing from the essence of the invention. Additionally, it should be noted that “comprising” and “comprising” do not exclude other elements or steps, and “one” or “a” do not exclude a plurality.

1. A method for converting data from a digital customer interface of a computer network system, the method including steps comprising:
acquiring standard functions both from participating systems of the computer network system and from the digital customer interface;
determining semantic relationships between the acquired standard functions; and
performing an orchestration in the form of a flexible combining of the captured standard functions based on the determined semantic relations to a data composition for internal material or value flows.

2. A method according to claim 1, wherein the participating systems include at least one of a web configurator, a web store, a simulation system, enterprise resource planning system, a production control system, or an auxiliary assembly machine.

3. A method according to claim 1, wherein the data composition for the internal material and/or value flows is transmitted to the participating systems or to the digital customer interface.

4. A method according to claim 1, wherein performing the orchestration comprises applying a data transformation to the acquired standard functions.

5. A method according to claim 1, wherein, based on the data composition for the internal material and/or value flows, automated control of production machines or production facilities coupled to the computer network system is performed.

6. A method according to claim 1, wherein the flexible combining of the acquired standard functions based on the determined semantic relationships to the data composition for internal material or value flows takes place upon completion of an ordering process of the digital customer interface.

7. An apparatus for converting data from a digital customer interface of a computer network system, the apparatus comprising:
an acquisition module adapted to acquire standard functions from both participating systems of the computer network system and the digital customer interface;
a semantics module adapted to determine semantic relationships between the acquired standard functions; and
an orchestration module adapted to perform an orchestration in the form of a flexible combining of the captured standard functions based on the determined semantic relationships into a data composition for internal material or value flows.

8. An apparatus according to claim 7, wherein the device further comprises a data transmission module which is designed to transmit the data composition for internal material or value flows to the participating systems or to the digital customer interface.

9. An apparatus according to claim 7, wherein the device is further adapted to be operated in a standard mode or in a simulation mode

10. An apparatus according to claim 7, wherein the apparatus is further adapted to flexibly combine the captured standard functions based on the determined semantic relationships to the data composition for internal material or value flows upon completion of an ordering process of the digital customer interlace.

11. A computer network system comprising:
an acquisition module adapted to acquire standard functions from both participating systems of the computer network system and the digital customer interface.
a semantics module adapted to determine semantic relationships between the acquired standard functions; and
an orchestration module adapted to perform an orchestration in the form of a flexible combining of the captured standard functions based on the determined semantic relationships into a data composition for internal material or value flows.

12. A computer network system according to claim 11, comprising a web configurator, a web store, a simulation system, enterprise resource planning system, a production control system, or an automatic assembly aid

13. A computer network system according to claim 11, wherein the computer network system is designed as a heterogeneous information technology (IT) system.
